(19) United States
(12) Patent Application Publication
(10) Pub. No.: US 2014/0114713 A1
(43) Pub. Date: Apr. 24, 2014

(54) INCIDENT ASSIGNMENT

(71) Applicant: HEWLETT-PACKARD DEVELOPMENT COMPAN, HOUSTON, TX (US)

(72) Inventors: YONATAN BEN SIMHON, NETANYA (IL); IRA COHEN, MODIIN (IL); YOHAY GOLAN, KFAR VITKIN (IL); ERAN SAMUNI, RAMAT GAN (IL)

(73) Assignee: HEWLETT-PACKARD DEVELOPMENT COMPANY, L.P., HOUSTON, TX (US)

(21) Appl. No.: 13/659,227

(22) Filed: Oct. 24, 2012

(51) Int. Cl. G06Q 10/06

(52) U.S. Cl. 705/7.14

(57) ABSTRACT

Systems, methods, and machine-readable and executable instructions are provided for incident assignment. Incident assignment can include selecting a number of incidents that have been resolved, wherein the number of incidents are similar to a pending incident. Incident assignment can also include identifying a first number of users that resolved the number of incidents and a number of skills associated with the first number of users. Incident assignment can include creating a target user profile based on the number of skills. Incident assignment can include computing a distance from each of a second number of users to the target user profile, wherein the distance computation does not penalize the second number of users for being over qualified. Incident assignment can also include assigning the pending incident to a selected user from the second number of users wherein the selected user is selected based on the computed distances.

### BACKGROUND

Information technology (IT) system management can include addressing a number of problems. Addressing problems can cause downtime in an IT system. Problems can cause a slow response time of business services. Slowed response time of business services can add to the cost of operating a business.

### BRIEF DESCRIPTION OF THE DRAWINGS

FIG. 1 is a flow chart illustrating an example of a method for incident assignment according to the present disclosure.

FIG. 2 is a diagram illustrating an example of a number of skills of a number of users according to the present disclosure.

FIG. 3 illustrates an example of a computing system according to the present disclosure.

### DETAILED DESCRIPTION

A number of resolved incidents can be selected based on their similarity to a pending incident. A target user profile can be created based on a number of skills required to resolve the number of resolved incidents. The target user profile can be used to select a user to resolve the pending incident. The selection can be performed without penalizing the user for being more proficient at resolving the incident than the proficiency embodied in the target user profile. Selecting a user that is qualified by analyzing the number of resolved incidents can limit the down time associated with a pending incident.

As used herein, an incident can include a problem that is associated with an IT component. An incident can also include other irregularities associated with an IT component. A problem can be caused by an error and/or a fault in an IT component. Problems can be reported in the form of a ticket, among other forms of reports. Incidents can be pushed into a dedicated system that manages a problem resolution lifecycle. Incidents can be assigned to a user by the dedicated system that manages the problem resolution lifecycle.

IT components can include logical components and/or physical components. For example, a logical component can include machine readable instructions to perform a particular task (e.g., instruction module). A physical component can be hardware to a computer system (e.g., a processor, memory, I/O port, bus, etc.). In a number of examples of the present disclosure, an IT component can have a number of subcomponents.

A problem resolution lifecycle can include detecting a problem, diagnosing the problem, and repairing the problem. The problem resolution lifecycle can also include recovering and restoring the IT component after a problem has been repaired (e.g., resolved). The down time associated with resolving a problem can include a mean time to repair (MTTR).

A MTTR can include the time between detecting a problem and restoring an IT component after the problem has been resolved. A contributing factor to MTTR can be the effectiveness of a user in resolving a problem. For example, a user that does not have the expertise, experience, and/or familiarity required to resolve a problem can take longer to resolve a problem than a user that has the expertise, experience, and/or familiarity required to resolve the problem. In a number of examples of the present disclosure, selecting a user to resolve a problem can include identifying the expertise, experience, or training required to resolve the problem, determining the expertise associated with a number of users, and assessing the distance between the expertise required to resolve the problem and the expertise associated with a number of users.

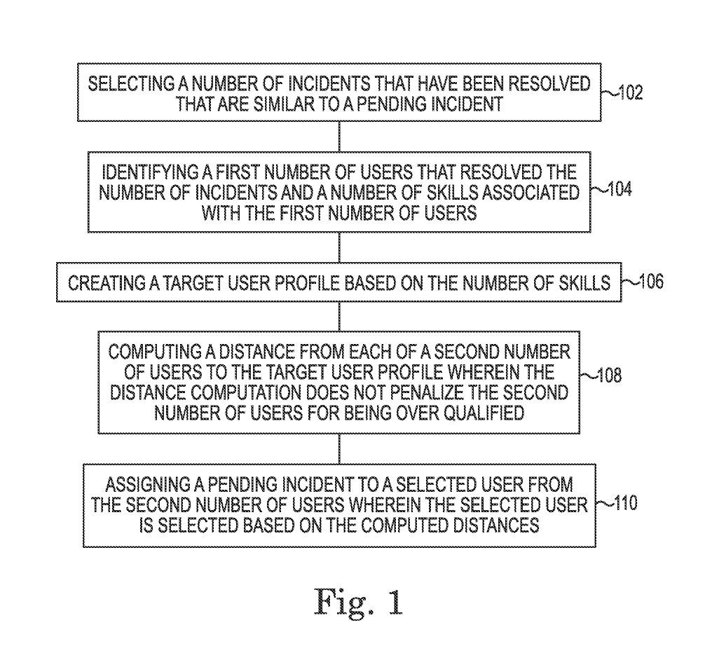

FIG. 1 is a flow chart illustrating an example of a method for incident assignment according to the present disclosure. At block 102, a number of incidents that have been resolved that are similar to a pending incident can be selected. Selecting can include executing instructions to select from a number of resolved incidents stored in memory as a historical set of data based on a set of features or criteria that identify incidents that have been successfully resolved.

The number of resolved incidents can include incidents that have been resolved in a predetermined time period. The predetermined time period can be associated with a pending incident. For example, a predetermined time period can include the last five months and/or any other time period that spans back in time from a pending incident. Different pending incidents can have different predetermined time periods. For example, a first pending incident can be associated with a first time period while a second pending incident can be associated with a second time period that is different than the first time period. A predetermined time period can be associated with a pending incident through a history of updates (e.g., update history) of a number of IT components that are associated with the pending incident, among other examples. For example, if a pending incident occurred in a hard drive and if the hard drive had been replaced with a different model three months before the occurrence of the pending incident, then the predetermined time period can be three months.

A pending incident can be a report that is generated once a problem is detected. And, a pending incident can be a report of a problem that has not been resolved and/or has not been assigned to a user. As used herein, a user can be an IT representative that can be assigned to resolve a pending incident and/or an incident that has been assigned but needs to be reassigned.

A number of resolved incidents can be selected based on a similarity to a pending incident. A set of resolved incidents, for example, can include a subset of incidents that are associated with a particular problem that is related to a problem from which the pending incident was generated. As used herein, a set of resolved incidents can include a set of resolved incidents that contains all resolved incidents. The subset of incidents can be a number of resolved incidents that can be selected. In a number of examples of the present disclosure, a number of resolved incidents can include all of the resolved incidents in a historical set of data and/or a subset of the resolved incidents in the historical set of data. A number of resolved incidents can be similar to a pending incident through a number of features that can define the pending incident and the number of resolved incidents. A number of features can include features pertaining to a logical structure of IT components associated with an incident. A number of features can also include features pertaining to a particular problem, e.g., root cause of the problem, and/or features pertaining to a business impact, among other features.

Features pertaining to a logical structure of IT components can include a single IT component where the problem occurred and/or an anomaly topology of a number of IT components that are associated with an incident. A single IT component can be an IT component where the problem occurred. For example, a single IT component can be a server and/or an application from where a problem occurs. An anomaly topology, for example, can include an application, a server, and/or a network wherein the application is running on the server that is part of the network. An anomaly topology can provide context from which to identify incidents that are similar.

Features pertaining to a particular problem can include details of a particular problem. For example, features pertaining to a particular problem can include an exception message and/or an error report. Features pertaining to a particular problem can include a description of a context and/or a context where an error occurred. For example, a feature pertaining to a particular problem can include a document (e.g., a description of a context) were an error occurred and/or a line (e.g., a context) within a document were an error occurred. A feature pertaining to a particular problem can also include, for example, an error message (e.g., a description of a context) that can include a description of an error and/or a document (e.g., a context) where the error occurred.

Features pertaining to a business impact can include a business unit where the incident occurred. For example, a feature pertaining to a business impact can be an accounting unit within a corporation, an impact on internet sales, and/or the servers in a region of the world when the servers are organized under a particular business unit.

At block 102, selecting a number of incidents that have been resolved can include executing instructions to select a number of incidents that have been resolved that meet a similarity threshold. A similarity threshold can be used to determine when a resolved incident is sufficiently similar to a pending incident. A similarity threshold can be used to determine when a feature that is associated with a resolved incident is sufficiently similar to a pending incident and/or when a number of features that are associated with the resolved incident are sufficiently similar to the pending incident. Each feature and/or all of the features associated with a resolved incident can have a similarity score. A similarity score can be unique to a feature and/or a number of features. For example, comparing a pending incident against each of a historical set of resolved incidents can include comparing a number of similarity scores against a similarity threshold to determine how similar the pending incident is to each of the resolved incidents in the historical set. From the historical set of resolved incidents a number of resolved incidents can be selected when the selected incidents include incidents that have associated similarity scores that are greater and/or equal to a similarity threshold. A similarity threshold can be unique to a pending incident. For example, a first pending incident that is associated with a first problem can have a similarity threshold that is higher than a second pending incident that is associated with a second problem wherein the first and the second problems are different.

At block 104, a first number of users that resolved the resolved incidents can be identified and a number of skills associated with the first number of users can be identified. A number of resolved incidents can be used to identify a number of skills that can be associated in the resolution of a pending incident. A number of skills can be obtained by analyzing the skills that a number of users, who resolved the number of resolved incidents, have and/or have used to resolve the number of resolved incidents.

Each incident that has been resolved can have an associated number of users who assisted in the resolution of the incident. For example, a resolved incident could have been resolved by a first user, a second user, and/or a third user, wherein each user could have contributed to the resolution of the resolved incidents. The first user could have contributed by resolving a first part of a problem associated with the incident, the second user could have contributed by resolving a second part of a problem, while a third user could have contributed by resolving a third part of a problem. A single user could have resolved a problem associated with an incident without the assistance of other users.

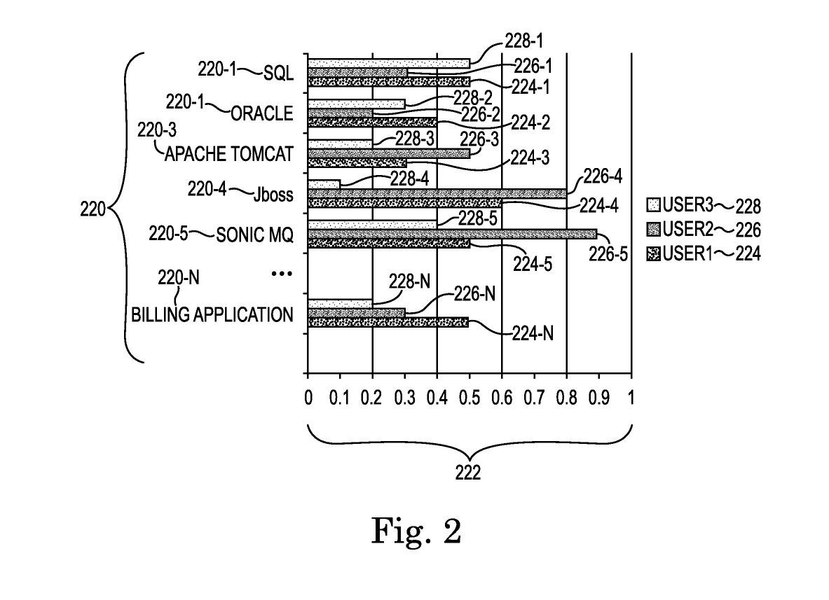

Each of the users can have a number of skills. An example of a number of skills is described in FIG. 2. A skill can be associated with a measured value of the skill. The measured value of the skill can describe the proficiency and/or familiarity that a user has with a particular skill. Skills and their associated measured values can be combined into a skill vector.

At block 106, a target user profile based on the number of skills can be created. A target user profile can include a profile of skills that identify the skills that can be used to resolve a pending incident and associated measured values of proficiency in those skills. Creating a target user profile can include creating an importance score for each skill in a skill vector. An importance score can describe a target proficiency in the skills that can be used to resolve the pending incident.

An importance score for a particular skill can be computed from an average of the particular skill and a variance of the particular skill. For example, if a skill vector includes a first skill, then an importance score can be created for the first skill from an average of the measured values of the skill from all of the skill vectors associated with a number of users and from a variance of the number of measured values of the particular skill from the number of users. Computing an importance score can also include determining if the average is greater than an average threshold and if the variance is less than a variance threshold.

If it is determined, for each the skills that are associated with the first number of skill vectors, that the average is greater than the average threshold and the variance is less than the variance threshold, then a particular importance score can be assigned a value equal to the average for a particular skill in the first number of skill vectors. If it is determined, for each of the skills in the first number of skill vectors, that the average is less than or equal to the average threshold or the variance is greater than or equal to that the variance threshold, then the particular importance score can be assigned the value equal to zero. A target user profile can include an importance vector that can include an importance score for each of the number of skills.

A target user profile can be an anchor point against which a second number of users can be compared. A second number of users can include users that can be assigned a pending incident. Users can be compared against a target user profile by comparing the importance vector associated with the target user profile against a number of skill vectors associated with the second number of users. Each of the users from the second number of users can have an associated skill vector.

At block 108, a distance from each of a second number of users to the target user profile can be computed, wherein the distance computation does not penalize the second number of users fore being over qualified. Computing a distance can include transforming each of the skill vectors associated with the second number of users.

A skill vector can be transformed to neutralize any overqualification that may be associated with the skill vector. A user can be overqualified when a user is more proficient in a particular skill than a target user profile. A transformation can include determining whether each measured value, associated with a particular skill, in each of the second number of skill vectors is greater than an associated importance score from an importance vector wherein a number of importance scores describe an importance of an associated skill in the target user profile. If it is determined that a particular measured value from one of the skill vectors from the second number of skill vectors is greater than the associated importance score, then the particular measure value can be set equal to the associated importance score. In a number of examples of the present disclosure, a number of different transformation can be used.

For example, a skill vector that includes a 0.9 measured value, which is associated with a first skill, can be over qualified as compared to an importance vector that includes a 0.7 measured value that is also associated with the first skill. The skill vector and/or user can be over qualified, with regards to the first skill, over the importance vector with regards to the first associated skill by an amount of 0.2. If it is determined that an measured value, e.g., 0.9, for the first skill in the first skill vector is greater than a measured value, e.g., 0.7, for the first skill in the importance vector, then the measured value for the first skill in the first skill vector can be changed to 0.7. The example given here can be repeated for each of the skills in a skill vector.

Computing a distance from a user to a target user profile can include computing a euclidean distance. For example, a euclidean distance can include subtracting each measured value from an importance vector that is associated with the desired user profile from an associated measured value from a skill vector that is associated with the user. The absolute value can be taken of each of the results of the subtraction calculations. The results of each absolute value calculation can be squared. The results of the square calculations can be summed. A square root of the result of the sum calculation can be a distance between a user and a user profile. For example, a distance between a user and a target user profile can be given as:

Distance (a, b)=\sqrt{|a₁−b₁|²+|a₂−b₂|²+ . . . +|aₙ−bₙ|²}.

The distance can express how qualified a user is to resolve a pending issue. In a number of examples of the present disclosure, other distance formulas can be used.

At block 110, instructions can be executed to assign the pending incident to a selected user from the second number of users, wherein the selected user can be selected based on the computed distances. The pending incident can be assigned to a user with a lowest distance to the target user profile as compared to the distances from the other users in the second number of users.

An assignment can further be based on a load balance of the second number of users. For example, if a first user with the lowest distance to the target user profile is currently assigned to another (e.g., second) pending incident, then a first pending incident can be assigned to a second user with a next lowest distance, wherein the first pending incident is an incident that is being assigned.

FIG. 2 is a diagram illustrating an example of a number of skills of a number of users according to the present disclosure. In FIG. 2, a number of users can include a first user 224, a second user 226, and a third user 228. A number of users can have a number of skills 220. A number of skills can include skills associated with a number of technologies. A number of technologies can include applications, programming languages, and/or environments, among other technologies. For example, a number of technologies can include SQL 220-1, Oracle 220-2, Apache Tomcat 220-3, Jboss 220-4, Sonic MQ 220-5, . . . , and/or a Billing Application 220-N, among other technologies. In a number of examples of the present disclosure, a skill can be a particular technology and/or knowledge in a particular technology.

A skill vector can further include a number of measured values 222 that are associated with each technology, e.g., skill. For example, a first user 224 can have a measured value 224-1 of 0.5 that is associated with an SQL technology 220-1, a measured value 224-2 of 0.4 that is associated with an ORACLE technology 220-2, a measured value 224-3 of 0.3 that is associated with an APACHE TOMCAT technology 220-3, a measured value 224-4 of 0.6 that is associated with a Jboss technology 220-4, a measured value 224-5 of 0.5 that is associated with a SONIC MQ technology 220-5, . . . , a measured value 224-N of 0.5 that is associated with a Billing Application technology 220-N. A second user 226 can have a measured value 226-1 of 0.3 that is associated with an SQL technology 220-1, a measured value 226-2 of 0.2 that is associated with an ORACLE technology 220-2, a measured value 226-3 of 0.5 that is associated with an APACHE TOMCAT technology 220-3, a measured value 226-4 of 0.8 that is associated with a Jboss technology 220-4, a measured value 226-5 of 0.9 that is associated with a SONIC MQ technology 220-5, . . . , a measured value 226-N of 0.3 that is associated with a Billing Application technology 220-N. A third user 228 can have a measured value 228-1 of 0.5 that is associated with an SQL technology 220-1, a measured value 228-2 of 0.3 that is associated with an ORACLE technology 220-2, a measured value 228-3 of 0.2 that is associated with an APACHE TOMCAT technology 220-3, a measured value 228-4 of 0.1 that is associated with a Jboss technology 220-4, a measured value 228-5 of 0.4 that is associated with a SONIC MQ technology 220-5, . . . , a measured value 228-N of 0.2 that is associated with a Billing Application technology 220-N.

A measured value in a skill vector that is associated with a first user 224 can be expressed as (SQL, 0.5). A skill vector that is associated with a first user 224 can be expressed as {(SQL, 0.5), (Oracle, 0.4), (Apache Tomcat, 0.3), (Jboss, 0.6), (Sonic MQ, 0.5), . . . , (Billing Application, 0.5)} and/or {0.5, 0.4, 0.3, 0.6, 0.5, . . . , 0.5}. A skill vector that is associated with a second user 226 can be expressed as {0.3, 0.2, 0.5, 0.8, 0.9, . . . , 0.3}. A skill vector that is associated with a third user {0.5, 0.3, 0.2, 0.1, 0.4, . . . , 0.2}. In a number of examples of the present disclosure, other implementations of a skill and/or a skill vector can be used.

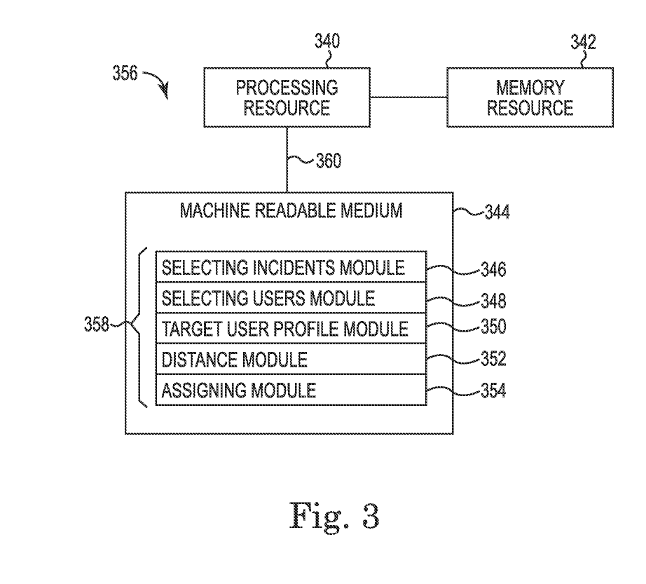

FIG. 3 illustrates an example of a computing system according to the present disclosure. The computing system 356 can utilize software, hardware, firmware, and/or logic to perform a number of functions.

The computing system 356 can be a combination of hardware and program instructions configured to perform a number of functions (e.g., actions). The hardware, for example, can include one or more processing resources 340, a machine readable medium (MRM) 344, and other memory resources 342, etc. The program instructions, e.g., machine-readable instructions (MRI) 358, can include instructions stored on the MRM 344 to implement a particular function, e.g., an action such as an incident assignment.

The processing resources 340 can be in communication with the tangible non-transitory MRM 344 storing the set of MRI 358 executable by one or more of the processing resources 340, as described herein. The MRI 358 can also be stored in a remote memory (e.g., 342) managed by a server and represent an installation package that can be downloaded, installed and executed. A computing device 356 (e.g., server) can include memory resources 342, and the processing resource 340 can be coupled to the memory resource 342 remotely in a cloud computing environment.

Processing resource 340 can execute MRI 358 that can be stored on internal or external non-transitory MRM 344. The processing resource 340 can execute MRI 358 to perform various functions (e.g., acts), including the functions described with respect to FIG. 1 and FIG. 2, among others.

As shown in FIG. 3 the MRI 358 can be segmented into a number of modules (e.g., a selecting incidents module 346, a selecting users module 348, a target user profile module 350, a distance module 352, and an assignment module 354) when executed by the processing resource 340 can perform a number of functions. As used herein a module includes a set of instructions included to perform a particular task or action. The number of modules 346, 348, 350, 352, and 354 can be sub-modules of other modules. For example, the selecting incident module 346 and the selecting users module 348 can be sub-modules and/or contained within a single module. Furthermore, the number of modules 346, 348, 350, 352, and 354 can comprise individual modules separate and distinct from one another.

In the example of FIG. 3, a selecting incidents module 346 can comprise MRI 358 that are executed by the processing resource 340 to select a number of incidents that are similar to a pending incident. As the same has been described in connection with FIG. 1, the number of incidents can be similar to a pending incident through a number of features that define the number of incidents and the pending incident. In a number of examples of the present disclosure, a number of resolved incidents can also be selected based on an incident resolve time. An incident resolve time can include diagnosing a problem, repairing the problem, recovering information associated with the resolution of a problem, and/or restoring an IT component that is associated with the problem. A number of incidents that are similar to the pending incidents can be selected based on a low incident resolve time. A low incident resolve time that is associated with the subset of the number of incidents can be low in relation to the resolve times of the resolved incidents.

A selecting users module 348 can comprise MRI 358 that are executed by the processing resource 340 to select a number of users and a number skills that are associated with the number of users. Selecting a number of users can include selecting users that contributed to the resolution of the number of selected resolved incidents. The users can be selected to obtain the measured values of the skills that where used in the resolution of the number of resolved incidents. Skills that were used in the resolution of the number of selected resolved incidents can be skills that can be used to resolve a pending incident.

A target user profile module 350 can comprise MRI 358 that are executed by the processing resource 340 to create a target user profile from the number of skills. A target user profile can represent a user that contains the skills necessary to resolve a pending incident.

A distance module 352 can comprise MRI 358 that are executed by the processing resource 340 to compare a number of users, that can be assigned a pending incident, to the target user profile. A distance, between a particular user's profile and a target profile can be calculated for each of the number of users. A distance can be used to determine how qualified a user is to resolve a pending incident. A distance can be computed such that users are not penalized for being over qualified to resolve an incident as compared to the target user profile.

In a number of examples of the present disclosure, a user can be penalized, in calculating a distance, for being overqualified. For example, a first user can be penalized for being overqualified to resolve a first incident. Penalizing the first user can result in the first incident being assigned to a second user that is not as qualified to resolve the first incident as the first user. The first user who was not assigned the first incident can be available to resolve a second incident that requires a higher proficiency in a number of skills that are associated with the resolution of the first incident.

An assignment module 354 can comprise MRI 358 and can be executed by the processing resource 340 to assign the pending incident to a user based on the computed distances. A number of other factors can be used in assigning the pending incidents in conjunction with the computed distances. For example, a factor can include a load balance of the number of users, among other factors.

A non-transitory MRM 344, as used herein, can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory MRM 344 can be integral or communicatively coupled to a computing device in a wired and/or wireless manner. For example, the non-transitory MRM 344 can be an internal memory, a portable memory, and a portable disk, or a memory associated with another computing resource, e.g., enabling MRIs 358 to be transferred and/or executed across a network such as the Internet.

The MRM 344 can be in communication with the processing resource 340 via a communication path 360. The communication path 360 can be local or remote to a machine, e.g., a computer, associated with the processing resource 340. Examples of a local communication path 360 can include an electronic bus internal to a machine, e.g., a computer, where the MRM 344 is one of volatile, non-volatile, fixed, and/or removable storage medium in communication with the processing resource 340 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 360 can be such that the MRM 344 is remote from a processing resource, e.g., processing resource 340, such as in a network connection between the MRM 344 and the processing resource, e.g., processing resource 340. That is, the communication path 360 can be a network connection. Examples of such a network connection can include local area network (LAN), wide area network (WAN), personal area network (PAN), and the Internet, among others. In such examples, the MRM 344 can be associated with a first computing device and the processing resource 340 can be associated with a second computing device, e.g., a Java® server. For example, a processing resource 340 can be in communication with a MRM 344, wherein the MRM 344 includes a set of instructions and wherein the processing resource 340 is designed to carry out the set of instructions.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for incident assignment comprising:
selecting a number of incidents that have been resolved, wherein the number of incidents are similar to a pending incident and wherein the number of incidents and the pending incident represent a number of problems that are associated with a number of information technology (IT) components;
identifying a first number of users that resolved the number of incidents and a number of skills associated with the first number of users;
creating a target user profile based on the number of skills;
computing a distance from each of a second number of users to the target user profile, wherein the distance computation does not penalize any of the second number of users for being over qualified; and
assigning the pending incident to a selected user from the second number of users wherein the selected user is selected based on the computed distances.

2. The method of claim 1, wherein selecting the number of incidents that are similar to the pending incident includes selecting based on a number of features that define the pending incident and the number of incidents.

3. The method of claim 2, wherein the number of features includes at least one of:
a problem domain that defines where the pending incident and the number of incidents occurred;
a business impact that identifies a business unit where the pending incident and the number of incidents occurred; and
a problem root cause that identifies a cause of the incident.

4. The method of claim 2, wherein selecting the resolved incidents that are similar to the pending incident includes selecting based on a first anomaly topology that is associated with the pending incident and a second anomaly topology that is associated with the resolved incidents wherein the first anomaly topology and the second anomaly topology define a number of IT components that are associated with the pending incident and the resolved incidents, respectively.

5. The method of claim 1, wherein assigning the pending incident to the selected user includes assigning based on the computed distances and on a load balance on the second number of users.

6. A non-transitory machine-readable medium storing instructions for incident assignment executable by a computer to cause the computer to:
select a number of incidents that have been resolved within a predetermined time period;
wherein the predetermined time period is selected by referencing a cause of a pending incident;
wherein the resolved incidents meet a similarity threshold that is associated with the pending incident; and
wherein the number of incidents and the pending incident represent a number of problems that are associated with a number of information technology (IT) components;
identify a first number of users that resolved the number of incidents and a number of skills associated with the first number of users;
creating a target user profile based on the number of skills;
compute a distance from each of a second number of users to the target user profile, wherein the distance computation does not penalize any of the second number of users for being over qualified; and
assign the pending incident to a selected user from the second number of users wherein the selected user is selected based on the computed distances.

7. The medium of claim 6, wherein the instructions are executable to identify users that contributed to a resolution of the resolved incidents.

8. The medium of claim 6, wherein the instructions are executable to identify a number of technologies and a respective measured value that represents a familiarity with each of the technologies for each of the second number of users.

9. The medium of claim 8, wherein the instructions are executable to:
identify a measured value having a value between a first value and second value for each technology; and
assign the second value to any technology that does not have a measured value.

10. The medium of claim 6, wherein the instructions are executable to:
calculate a similarity score for each of the number of incidents; and
compare the number of similarity scores against the similarity threshold to determine which of the number of incidents to select.

11. A system for incident assignment, comprising:
a processing resource in communication with a memory resource, wherein the memory resource includes a set of instructions, executable by the processing resource to:
select a number of incidents that have been resolved, wherein the number of incidents are similar to a pending incident and wherein the number of incidents and the pending incident represent a number of problems that are associated with a number of information technology (IT) components;
identify a first number of users that resolved the number of incidents and a respective skill vector associated with each of the first number of users;
create a target user profile based on the first number of skill vectors;
compute a distance from each of a second number of users to the target user profile, wherein the distance computation does not penalize any of the second number of users for being overqualified; and
assign the pending incident to a selected user from the second number of users wherein the selected user is selected based on the computed distances.

12. The system of claim 11, wherein the instructions are executable to create an importance vector by computing an importance score for each skill that is associated with the respective skill vectors.

13. The system of claim 12, wherein the instructions are executable to:
compute an average for each skill that is associated with the respective skill vectors;
compute a variance for each skill that is associated with the respective skill vectors;
determine, for each skill, if the average is greater than an average threshold and if the variance is less than a variance threshold;
assign a value equal to the average for a particular skill as the importance score for the particular skill in response to the average being greater than the average threshold and the variance being greater than the variance threshold; and
assign a value equal to zero as the importance score for the particular skill in response to the average being less than or equal to the average threshold or the variance being less than or equal to the variance threshold.

14. The system of claim 11, wherein the instructions are executable to transform a respective skill vector that is associated with each of the second number of users such that the second number users are not overqualified.

15. The system of claim 14, wherein the instructions are executable to:
determine whether each skill in each of the second number of skill vectors is greater than an associated importance score wherein a number of importance scores describe an importance of an associated skill in the target user profile; and
set a measured value in each of the second number of skill vectors equal to the associated importance score in response to each entry from the second number of skill vectors being greater than the associated importance score.
